(19) United States
(12) Patent Application Publication
(10) Pub. No.: US 2015/0359341 A1
(43) Pub. Date: Dec. 17, 2015

(54) TRAVEL PILLOW AND METHODS OF USE THEREOF

(71) Applicant: Kenny Thorbjornsen, Venice, CA (US)

(72) Inventor: Kenny Thorbjornsen, Venice, CA (US)

(21) Appl. No.: 14/172,399

(22) Filed: Feb. 4, 2014

Related U.S. Application Data
(60) Provisional application No. 61/760,362, filed on Feb. 4, 2013.

(51) Int. Cl. A47C 7/38; B60N 2/48; A47G 9/10

(52) U.S. Cl. CPC A47C 7/383; A47G 9/1009; B60N 2/48

(57) ABSTRACT

The invention includes a travel pillow comprising a Central Support Triangle (CST) configured to rest on the shoulders of two people sitting next to one another or on the shoulder of one person who is positioned adjacent to another secure object, two Comfort Pillows (CP) that provide a soft surface for a user's head, and two Comfort Pillow Slips (CPS) that serve as a cover for the CP, wherein the CPSs are attached on two opposite sides of the CST.

### CROSS REFERENCE TO RELATED APPLICATIONS

This application claims priority to U.S. Provisional Application Ser. No. 61/760,362, filed Feb. 4, 2013, which is incorporated herein by reference in its entirety.

### FIELD OF THE INVENTION

The present invention relates to a travel pillow for comfortably supporting a vehicle passenger's head.

### BACKGROUND OF THE INVENTION

Sleeping in the seat of a vehicle can often be uncomfortable and challenging. Many vehicles, including aircraft, are equipped with small travel pillows that are usually positioned between the passenger's head and the seat's headrest. However, the pillow intermittently shifts, waking the passenger and often disturbing an adjacent passenger. Furthermore, the head is usually supported in an awkward position that can cause neck cramps and other spinal ailments. Prolonged tilting of the head can cause neck strains, cramps and perhaps more severe medical problems.

Various travel pillows exist in the prior art that are purported to overcome many of the above-described problems. The most common travel pillow consists of a U-shaped or C-shaped cushion that encircles the neck to prevent the head from swaying or tilting. However, because a portion of the cushion rests between the nape of the neck and a seat backrest, the chin is forced downwardly, against the chest, which can be uncomfortable and disruptive.

Accordingly, there is currently a need for a travel pillow that overcomes the above-described disadvantages associated with conventional travel pillows.

### SUMMARY OF THE INVENTION

The present invention is a unique form and design of travel pillow that allows two people who are traveling and sitting next to each other to rest in an upright position using a pillow like object to rest or sleep comfortably. It has unique design, shape, size, function and material construction. It can also be used by a single person against another solid/secure object, i.e. the seat and/or tray in front of where you are sitting, or the edge/wall of a vehicle such as a train, car, bus or airplane (in the window seat).

The invention includes three basic components—the Central Support Triangle (CST) that sits in the middle of, i.e between two people, or sits between one person and another secure object. The second component is a Comfort Pillow (CP) which slips into the third component the Comfort Pillow Slip (CPS) which is attached with VELCRO® on two opposite sides of the CST.

The first component, the “Central Support Triangle” (CST) serves as the center and the principal support of the object. It is a triangle shaped object of unique size, dimension and material construction. When the CST sits between two people there is a portion of the bottom of the CST that sits/rests on each person's shoulder of the two people sitting side by side.

The dimensions of the Central Support Triangle (CST) are roughly 8″ tall×8″ long×5″ wide at the bottom and 3″ wide at the top. The CST is constructed of a Ethylene-Vinyl Acetate copolymer (EVA) or similar and can have a range of degree specific to the hardness. The preferred degree of hardness/density is 38 degrees.

The location of the centerline of VELCRO® “hooks” piece, which is embedded/attached on the CST, is 2″ down from the top of the CST. There are two ⅞″ VELCRO® square pieces embedded/attached to the CST. They are embedded/attached on two opposite (left & right) sides of the CST. These two pieces of VELCRO® on the CST is what each CPS piece of VELCRO® will attach to. This VELCRO® attachment is what helps hold the CP in place. Although reference is made here to the VELCRO® trademark, it is contemplated herein that the any similar securing functionality may be utilized, including, for exemplary purposes only and without limitation, tiny hooks and loops such as those generally associated with the VELCRO® trademark and/or general usage of the word “velcro” (whether or not such usage is in reference to the trademark and/or the trademark's owner).

A Comfort Pillow (CP) sits on two opposite sides of the CST. The preferred dimensions of the CP are either 8″ or 10″ diameter circle or square. The CP is constructed of any type of pillow material. The CP will be inserted into the third component, the CPS.

The Comfort Pillow Slip (CPS) is a basic pillow cover which will have a piece of VELCRO® (loop side) sewn on one side of the CPS. The top of the VELCRO® “loops” square will be sewn 3″ down from the top of the pillow and will be on the side opposite of an image, if present, on the CPS. The CPS is capable of having a 8″ or 10″ pillow fit within it. The CP will fit into the CPS through a small opening in the bottom of the CPS, which will have a basic zipper or button securement method. The VELCRO® “loops” side of the CPS will attach to one side of the CST which has VELCRO® “hooks” attached to it. The CPS can be removed and washed easily. Further, it is contemplated herein that the VELCRO® “loops” may be disposed on the CST and the “hooks” side may be disposed on the CPS.

Using the aforementioned three components, a person can slip two CPs into their own individual CPSs. Upon securing the CP within the CPS, each CPS/CP can be secured to the CST by attaching the VELCRO® loops on the CPS to the VELCRO® hooks on the CST. Once both CPS/CPs are attached to the CST the “Travel Triangle” can be used as intended.

The Travel Triangle is designed for two people sitting side by side. It works such that the CST rests in part on each person's shoulder allowing each person to lean on the CP which is on their respective side of the CST. With the CST resting on their shoulders, neither the CP's or CST will move. Thus the three pieces (CP-CST-CP) will act as a support between the people's heads so they can relax and rest while traveling in a sitting position. This same concept of using the Travel Triangle as a resting support works with a single person against another solid object/force as well.

The CST and CP's act as a support structure between the two opposing forces of the traveler's heads (or one person's head and another solid/secure object) so that each can rest their head comfortably without the Travel Triangle shifting greatly.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an axonometric view of a travel pillow according to one embodiment of the invention;

FIG. 2 illustrates a dimensional axonometric view of a travel pillow according to one embodiment of the invention;

FIG. 3 illustrates a front view of a travel pillow according to one embodiment of the invention;

FIG. 4 illustrates a side view of a travel pillow according to one embodiment of the invention;

FIG. 5 illustrates a bottom view of a travel pillow according to one embodiment of the invention;

FIG. 6 illustrates an axonometric view of a travel pillow with VELCRO® square dimensioning according to an alternative embodiment of the invention;

FIG. 7 illustrates a dimensional axonometric view of a travel pillow with VELCRO® square dimensioning according to an alternative embodiment of the invention;

FIG. 8 illustrates a front view of a travel pillow with VELCRO® square dimensioning according to an alternative embodiment of the invention;

FIG. 9 illustrates a side view of a travel pillow with VELCRO® square dimensioning according to an alternative embodiment of the invention;

FIG. 10 illustrates an enlarged view of the VELCRO® hooks according to one embodiment of the invention;

FIG. 11 illustrates a front view of a travel pillow with comfort pillows and comfort pillow slips disposed about the sides;

FIG. 12 illustrates a side view of a travel pillow with a comfort pillow and comfort pillow slip disposed about one of the sides;

FIG. 13 illustrates an enlarged view of the VELCRO® loops;

FIG. 14 illustrates a bottom view of a comfort pillow slip; and

FIG. 15 illustrates a front view of a travel pillow according to an embodiment of the invention with comfort pillows and comfort pillow slips disposed about the sides, with users positioned about the sides of the travel pillow.

### DETAILED DESCRIPTION OF THE PREFERRED EMBODIMENTS

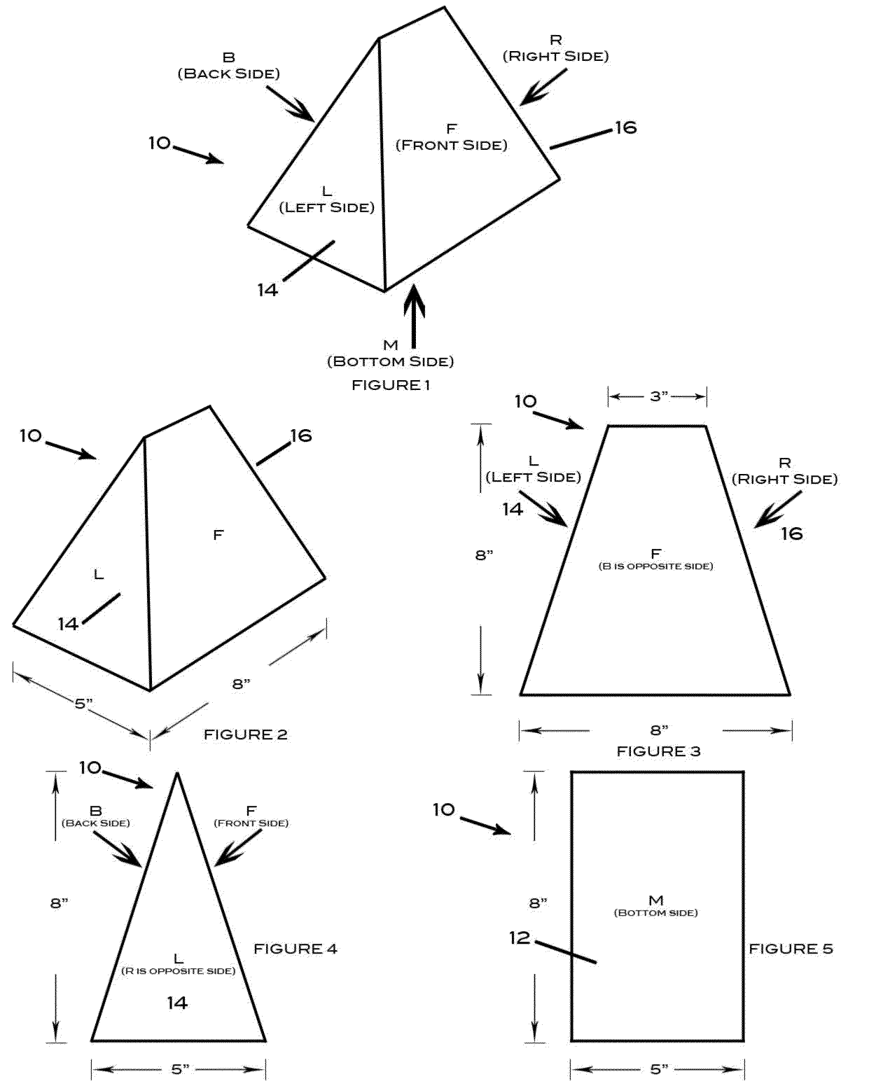

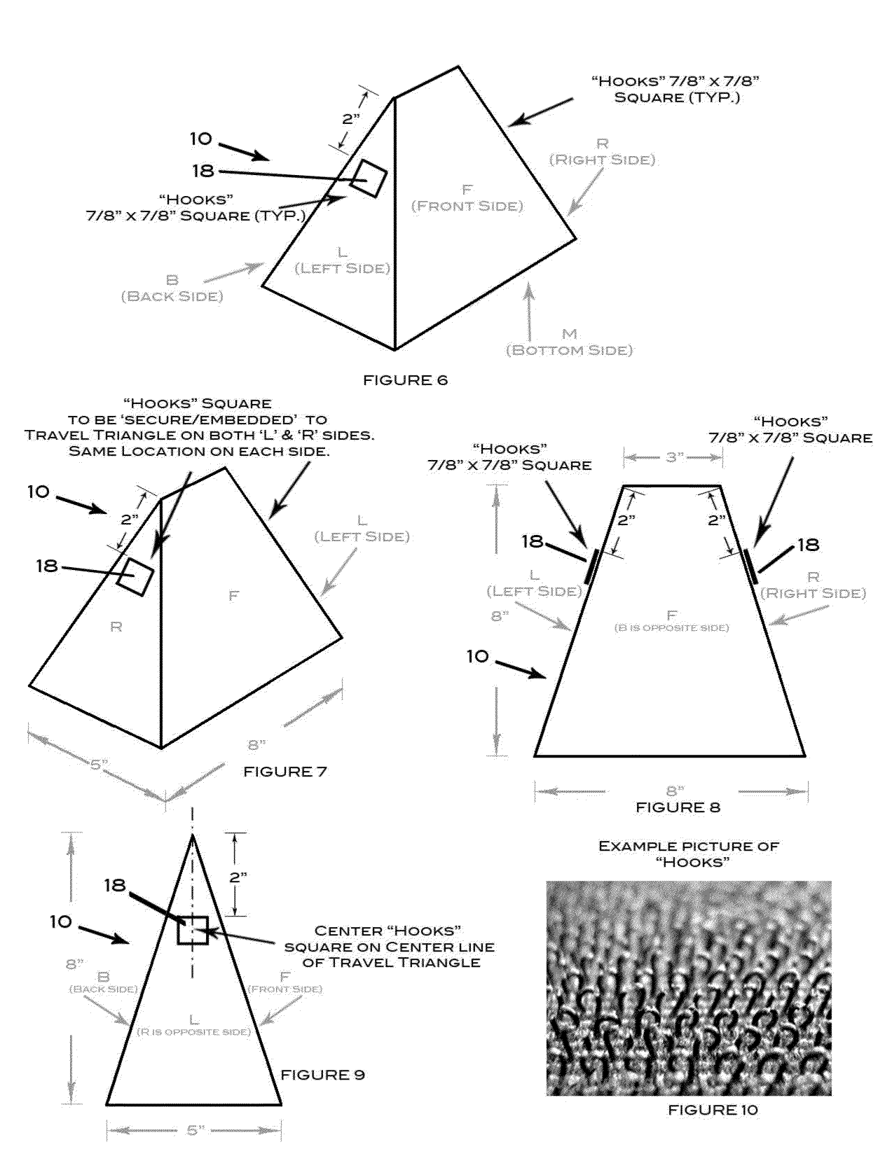

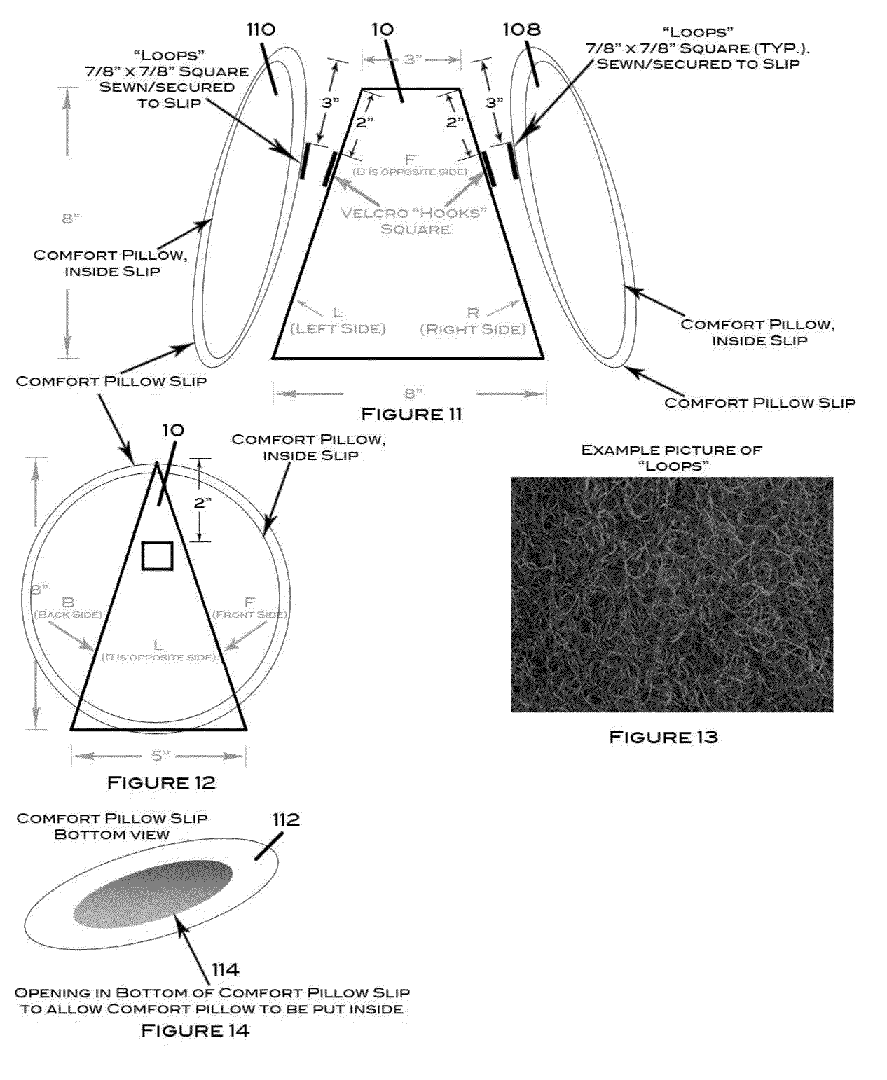

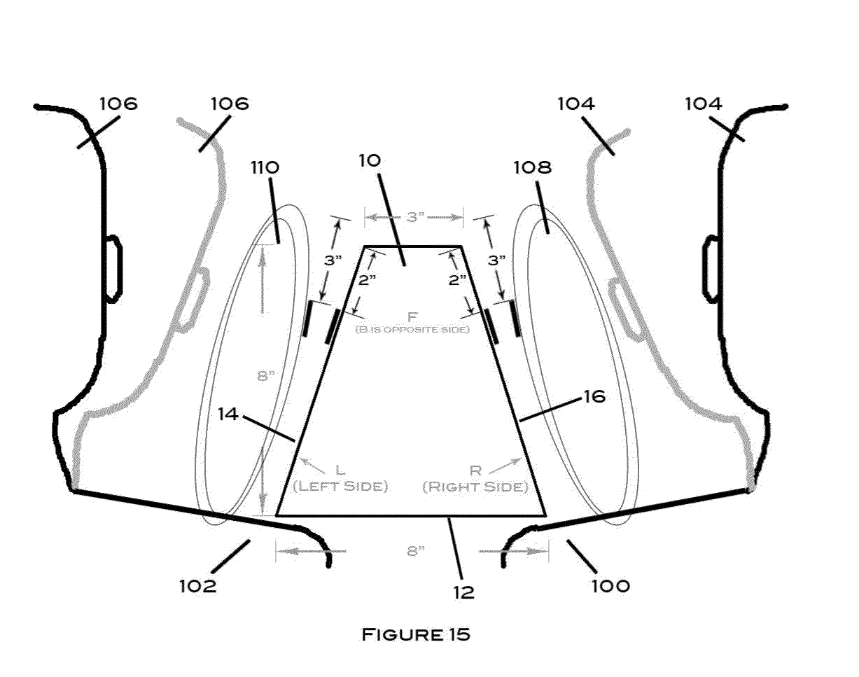

With reference to FIGS. 1-15, details of the Central Support Triangle (CST) 10 will now be discussed. The (CST) 10 serves as the center and the principal support of the invention. CST 10 is a triangle shaped object of unique size, dimension and material construction. When the CST is located between two people, as shown in FIG. 15, there is a portion of the bottom 12 of the CST 10 that sits/rests on each person's shoulder 100, 102 of the two people sitting side by side. In this position, passengers sitting next to one another can rest their heads 104, 106 on sides 16 and 14 respectively.

The dimensions of the Central Support Triangle (CST) 10 are roughly 8″ tall×8″ long×5″ wide at the bottom and 3″ wide at the top. CST 10 is constructed of a Ethylene-Vinyl Acetate copolymer (EVA), or similar, and can have a range of degree specific to the hardness. The preferred degree of hardness/density is 38 degrees.

FIGS. 6-10 show a means for attaching CP or CPS to the CST 10. In a preferred embodiment, CST 10 is attached to CPS with a hooks piece 18. CP or CPS are preferably positioned along a centerline of VELCRO® hooks piece 18, which may be embedded or attached on the CST 10. In a preferred embodiment, hooks piece 18 is 2″ below the top of the CST 10, as shown in FIGS. 6-9. There are two ⅞″ VELCRO® square pieces embedded/attached to the CST 10. They are embedded/attached on two opposite (left 14 & right 16) sides of the CST. These two pieces of VELCRO® on the CST 10 is what each CPS piece of VELCRO® will attach to. This VELCRO® attachment is what helps hold the CP in place.

A Comfort Pillow (CP) 108, 110 sits on two opposite sides of the CST 10. The preferred dimensions of the CP 108, 110 are either 8″ or 10″ diameter circle or square. The CP 108, 110 is constructed of any type of pillow material. The CP 108, 110 will be inserted into the third component, the CPS 112.

The Comfort Pillow Slip (CPS) 112 is a basic pillow cover which will have a piece of VELCRO® (loop side) sewn on one side of the CPS 112. The top of the VELCRO® “loops” square will be sewn 3″ down from the top of the pillow and will be on the side opposite of an image if present on the CPS 112. The CPS 112 is capable of having a 8″ or 10″ pillow fit within it. The CP 108, 110 will fit into the CPS through a small opening 114 in the bottom of the CPS 112, which may have a basic zipper or button securement method. The VELCRO® “loop” side of the CPS 112 will attach to one side of the CST 10 which has VELCRO® “hooks” attached to it. The CPS 112 can be removed and washed easily.

Using the aforementioned three components, a person can slip two CPs 108 into their own individual CPS 112. Upon securing the CP 108 within the CPS 112, each CPS/CP can be secured to the CST 10 by attaching the VELCRO® loops on the CPS 112 to the VELCRO® hooks on the CST 10. Once both CPS/CPs are attached to the CST 10 the “Travel Triangle” can be used as intended.

The Travel Triangle is preferably used by two people sitting side by side. It works such that the bottom 12 of CST 10 rests in part on each person's shoulder allowing each person to lean their head on the CP which is on their respective side of the CST 10. With the CST 10 resting on their shoulders, neither the CP's or CST 10 will move. Thus the three pieces (CP-CST 10-CP) will act as a support between the people's heads so they can relax and rest while traveling in a sitting position. This same concept of using the Travel Triangle as a resting support works with a single person against another solid object/force as well.

The CST 10 and CP's act as a support structure between the two opposing forces of the traveler's heads 104, 106 (or one person's head and another solid/secure object) so that each can rest their head comfortably without the Travel Triangle shifting greatly, as shown in FIG. 15.

The CP's will be attached on each side of the CST 10 with hooks piece 18. In one embodiment, the attachment material will have a dummy cover to them so the VELCRO® doesn't wear away.

In an alternative embodiment, the Travel Triangle can be packaged for easy transport while traveling. It will be packaged such that the CST 10, CPSs, and CPs can fit in a small plastic travel bag that can be clipped to a suitcase or packed away.

A detailed description of how the 3 “Travel Triangle” components work together is described above. In operation, a user can attach the CPS/CPs to the CST 10 via the VELCRO® attachments. The “Travel Triangle” can then be set between two forces, either on two peoples shoulders in between their heads or on one persons shoulder and against a wall, or on a table/pull out tray so a person's head can lean forward and the back of the chair acts as the other force. Once the “Travel Triangle” is at a spot that is somewhat stable, a person can rest their head(s) on their pillow and enjoy their sleep.

While the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A transportable travel pillow comprising:
a central support, wherein the central support comprises a first side and a second side that are disposed opposite each other, and wherein the central support further comprises at least two securing mechanisms, a first securing mechanism disposed on the first side and a second securing mechanism disposed on the second side;
a first head-support device having a securing mechanism, wherein the first head-support device's securing mechanism is removably attached to the central support's first securing mechanism; and
a second head-support device having a securing mechanism, wherein the second head-support device's securing mechanism is removably attached to the central support's second securing mechanism.

2. The transportable travel pillow of claim 1, wherein the first head-support device comprises a first slip and a first pillow, and wherein the first slip generally encloses the first pillow.

3. The transportable travel pillow of claim 2, wherein the second head-support device comprises a second slip and a second pillow, and wherein the second slip generally encloses the second pillow.

4. The transportable travel pillow of claim 3, wherein the central support further comprises a bottom side that is adjacent to both the first and second sides.

5. The transportable travel pillow of claim 4, wherein the central support further comprises a front side and a back side, both the front side and the back side being adjacent to each of the other four sides, respectively.

6. A method of utilizing a transportable travel pillow, the method comprising:
placing a bottom side of a transportable travel pillow device on a person's shoulder, the transportable travel pillow device comprising:
a central support that comprises a bottom side, a first side and a second side, the first and second sides being disposed opposite each other, wherein the central support's bottom side is the transportable travel pillow device's bottom side, and wherein the central support further comprises at least two securing mechanisms, a first securing mechanism disposed on the first side and a second securing mechanism disposed on the second side; and
a first head-support device having a securing mechanism; and
attaching the first head-support device's securing mechanism to the central support's first securing mechanism.

7. The method of claim 6, wherein the first head-support device comprises a first lip and a first pillow, the method further comprising:
placing the first pillow within the first slip.

8. The method of claim 6, wherein the central support further comprises a front side and a back side that are each adjacent to each of the other four sides, respectively.

9. The method of claim 8, wherein the first head-support device comprises a first slip and a first low, the method further comprising:
placing the first pillow within the first slip.

10. The method of claim 9, wherein the transportable travel pillow device further comprises a second head-support device having a securing mechanism, the method further comprising:
attaching the second head-support device's securing mechanism to the central support's second securing mechanism; and
placing the transportable travel pillow device on a second person's shoulder.

11. A transportable resting device comprising:
a central support, wherein the central support comprises a first side and a second side that are disposed opposite each other, and wherein the central support further comprises at least two securing mechanisms, a first securing mechanism disposed on the first side and a second securing mechanism disposed on the second side; and
a first head-support device having a securing mechanism, wherein the first head-support device's securing mechanism is removably attached to the central support's first securing mechanism.

12. The transportable travel pillow of claim 11, wherein the central support further comprises a bottom side that is adjacent to the first and second sides, the bottom side having a length that runs between the first and second sides, and wherein the central support further comprises a top edge, with a length, whose endpoints terminate at the first and second sides, and wherein the top edge's length is shorter than the bottom side's length.

13. The transportable travel pillow of claim 12, wherein the first side's securing mechanism is disposed nearer the top edge than the bottom side, and wherein the second side's securing mechanism is disposed nearer the top edge than the bottom side.

14. The transportable travel pillow of claim 13, wherein the securing mechanisms are selected from the group consisting of hooks and loops.

15. The transportable travel pillow of claim 14, the transportable travel pillow further comprising:
a second head-support device having a securing mechanism selected from the group consisting of hooks and loops, wherein the second head-support device's securing mechanism is removably attached to the central support's second securing mechanism.

16. The transportable travel pillow of claim 11, wherein the first head-support device comprises a first slip and a first pillow, the first head-support's securing mechanism being disposed on the first slip, and wherein the second head-support device comprises a second slip and a second pillow, the second head-support's securing mechanism being disposed on the second slip.

17. The transportable travel pillow of claim 16, wherein the securing mechanisms are selected from the group consisting of hooks and loops.

18. The transportable travel pillow of claim 17, wherein the central support further comprises a bottom side that is adjacent to the first and second sides, the bottom side having a length that runs between the first and second sides, and wherein the central support further comprises a top that is adjacent to the first and second sides but not the bottom side, the top having a length that runs between the first and second sides, and wherein the top's length is shorter than the bottom side's length.

19. The transportable travel pillow of claim 18, the transportable travel pillow further comprising:
a second head-support device having a securing mechanism, wherein the second head-support device's securing mechanism is removably attached to the central support's second securing mechanism.

20. The transportable travel pillow of claim 19, wherein the first side's securing mechanism is disposed nearer the edge than the bottom side, and wherein the second side's securing mechanism is disposed nearer the edge than the bottom side.
